(19) United States
(12) Patent Application Publication
(10) Pub. No.: US 2024/0356119 A1
(43) Pub. Date: Oct. 24, 2024

(54) Cylindrical Battery, Electric Apparatus and Manufacturing Method for Cylindrical Battery

(71) Applicant: Jiangsu Zenergy Battery Technologies Co., Ltd., Suzhou City (CN)

(72) Inventors: Hongjiang YU, Suzhou City (CN); Zhigao LUO, Suzhou City (CN); Jicheng CHEN, Suzhou City (CN)

(21) Appl. No.: 18/643,654

(22) Filed: Apr. 23, 2024

(30) Foreign Application Priority Data
Apr. 23, 2023 (CN) 202320922089.1

(51) Int. Cl. H01M 50/169; H01M 50/107; H01M 50/152; H01M 50/186

(52) U.S. Cl. CPC H01M 50/169; H01M 50/107; H01M 50/152; H01M 50/186

(57) ABSTRACT

The disclosure relates to the technical field of batteries, and in particular to a cylindrical battery, including: a housing, provided with an opening and an accommodating cavity for accommodating a cell; a first current collector, arranged in the accommodating cavity, and the first current collector includes a first main body portion and a second main body portion, the first main body portion is connected to the cell, and the second main body portion is connected to the housing; a side wall of the housing is provided with a beading portion, which is recessed towards the accommodating cavity to form a first groove on an outer wall of the housing, and correspondingly form a protrusion on an inner wall of the housing, at least a part of the second main body portion extends from an edge of the first main body portion to the protrusion and covers the protrusion.

### CROSS-REFERENCE TO RELATED APPLICATIONS

The disclosure claims priority to and the benefit of Chinese Patent Application No. 202320922089.1, filed with the China National Intellectual Property Administration (CHIPA) on Apr. 23, 2023, which is hereby incorporated by reference in its entirety.

### TECHNICAL FIELD

The disclosure relates to the technical field of batteries, and in particular, to a cylindrical battery, an electric apparatus and a manufacturing method for a cylindrical battery.

### BACKGROUND OF THE INVENTION

In the related art, a welding position and a beading portion need to be reserved in a cylindrical battery, which causes the height of a battery housing to be increased, which means that when a battery is assembled into a battery module, more internal spaces need to be reserved for the battery module, and the energy density is significantly reduced.

### SUMMARY OF THE INVENTION

A technical problem to be solved by the disclosure is to provide a cylindrical battery with a relatively low height, so as to reduce a space occupied by the cylindrical battery when the cylindrical battery is mounted into a battery module.

In order to solve the described technical problem, the disclosure adopt the following technical solutions:

Some embodiments of the disclosure provide a cylindrical battery, including: a housing, the housing is provided with an opening and an accommodating cavity for accommodating a cell; a first current collector, the first current collector is arranged in the accommodating cavity, and the first current collector includes a first main body portion and a second main body portion, the first main body portion is connected to the cell, and the second main body portion is connected to the housing; a side wall of the housing is provided with a beading portion, the beading portion is recessed towards the accommodating cavity to form a first groove on an outer wall of the housing, and correspondingly form a protrusion on an inner wall of the housing, at least a part of the second main body portion extends from an edge of the first main body portion to the protrusion and covers the protrusion.

In some embodiments, the second main body portion includes a welding segment and a limiting segment, the limiting segment is connected to the welding segment and the first main body portion, and the second main body portion is connected to the protrusion by the welding segment. Specifically, before the beading portion is recessed towards the accommodating cavity, the second main body portion includes a welding segment and a buffer segment located between the welding segment and the first main body portion, the beading portion is arranged corresponding to the buffer segment, and the buffer segment is able to be bent and deformed as the beading portion is recessed inwards; when the beading portion is recessed towards the accommodating cavity so that an inner side wall of the housing forms the protrusion correspondingly, the protrusion pushes the buffer segment such that the buffer segment is bent inwards and deformed to form the limiting segment. The protrusion and the limiting segment are integrally formed by a beading process, and no additional process is required to form the limiting segment so as to enable the limiting segment to be fitted and mounted.

In some embodiments, the welding segment is located on a side of the protrusion that is oriented towards the opening. The position of the welding segment is able to be directly subjected to laser welding, so that the welding segment is able to be fixedly connected to the protrusion.

In some embodiments, a length of the welding segment is less than a length of the limiting segment.

In some embodiments, the welding segment and the limiting segment abut against the protrusion. The limiting segment abutting against the protrusion is able to ensure a limiting and fixing effect, and the welding segment abutting against the protrusion is able to facilitate welding operations and welding effects.

In some embodiments, a cross section shape of the limiting segment is consistent with a cross section shape of the protrusion. The formed limiting segment has a shape consistent with that of the protrusion, which is able to further fix the first current collector.

In some embodiments, cross section shapes of the limiting segment and the protrusion are both V-shaped. A better limiting and fixing effect is able to be achieved by adopting the V-shaped forming shape.

In some embodiments, before the beading portion is recessed, the second main body portion includes the welding segment and a buffer segment located between the welding segment and the first main body portion, and the buffer segment is configured for being bent and deformed to form the limiting segment.

In some embodiments, a cross section shape of the buffer segment is zigzag or arc-shaped. Between two points, the zigzag and arc shapes have a longer length than a straight line, thereby enabling a middle portion of the buffer segment to provide a sufficient length of deformation

In some embodiments, before the beading portion is recessed, an extension direction of the second main body portion is perpendicular to that of the first main body portion. The second main body portion is perpendicular to the first main body portion, so that the first current collector added with the buffer segment is able to be directly mounted into the accommodating cavity.

In some embodiments, the first main body portion and the second main body portion are integrally formed. Such arrangement enables the first main body portion and the deformed limiting segment and the welding segment to have reliable structural strength.

In some embodiments, further including: a top cover assembly, the top cover assembly covers the opening and includes a top cover and a first insulating seal; the top cover is embedded in the first insulating seal, such that the top cover is insulated from the housing.

In some embodiments, the first current collector is a negative electrode connector.

Some other embodiments of the disclosure provide an electric apparatus, including the above cylindrical battery. The electric apparatus is a product such as a mobile phone, a watch, a vehicle, an electric toy, and an electric tool. Other specific structures of specific products thereof are similar to those in the related art, and will not be repeated herein again; and the main difference is that the cylindrical battery of the disclosure is applied.

Still some other embodiments of the disclosure further provide a manufacturing method for a cylindrical battery, configured for manufacturing the above cylindrical battery, including the following steps:
S1: winding to form a cylindrical cell, the cylindrical cell has a positive electrode tab and a negative electrode tab;
S2: flattening the positive electrode tab and the negative electrode tab of the cylindrical cell;
S3: welding the positive electrode tab to a second current collector, and welding the negative electrode tab to a first current collector, so as to obtain a cell assembly;
S4: placing the cell assembly into a housing;
S5: performing ultrasonic torque welding on the second current collector and a positive electrode terminal;
S6: performing beading on the housing, such that a beading portion of the housing is recessed inwards, an outer wall of the housing is recessed to form a first groove, and an inner wall of the housing is protruded to form a protrusion, a top of the protrusion pushes the buffer segment such that the buffer segment is bent inwards and deformed to form a limiting segment;
S7: welding the welding segment to the protrusion on a surface of the protrusion away from the cell assembly; and
S8: mounting a top cover assembly, and mounting the top cover assembly to an opening of the housing in a clamping manner.

In some embodiments, before the step S1, the manufacturing method further includes steps of: die-cutting a positive electrode plate to form a plurality of positive electrode tabs, and die-cutting a negative electrode plate to form a plurality of negative electrode tabs.

In some embodiments, in the step S6, the limiting segment forms a second groove, and the protrusion abuts against the second groove to fix the protrusion and the limiting segment.

In some embodiments, in the step S6, the protrusion and the limiting segment both form V-shaped cross sections.

The cylindrical battery of the disclosure has the following beneficial effects: the buffer segment is arranged corresponding to the beading portion of the housing, and when the cylindrical battery is subjected to a beading process, an inner wall of the beading portion protrudes such that the buffer segment is bent and deformed; at this time, the buffer segment stretches and is deformed, the welding segment is close to the protruding surface of the beading portion, and the welding segment is welded with and connected to the protruding surface of the beading portion. The welding positions are arranged corresponding to the beading portions, and two positions do not need to be reserved in the battery housing, thereby reducing the battery height.

### BRIEF DESCRIPTION OF THE DRAWINGS

FIG. 1 is a schematic sectional diagram of a side structure of a cylindrical battery in the related art.

FIG. 2 is a schematic sectional diagram of a side structure of a cylindrical battery which is not subjected to a beading process and is not mounted with a top cover assembly of the disclosure.

FIG. 3 is a schematic enlarged diagram of a partial structure of portion A in FIG. 2.

FIG. 4 is a schematic sectional diagram of a side structure of a cylindrical battery which is subjected to a beading process and is not mounted with a top cover assembly of the disclosure.

FIG. 5 is a schematic enlarged diagram of a partial structure of portion B in FIG. 4.

FIG. 6 is a schematic sectional diagram of a side structure of a cylindrical battery which is subjected to a beading process and is mounted with a top cover assembly of the disclosure.

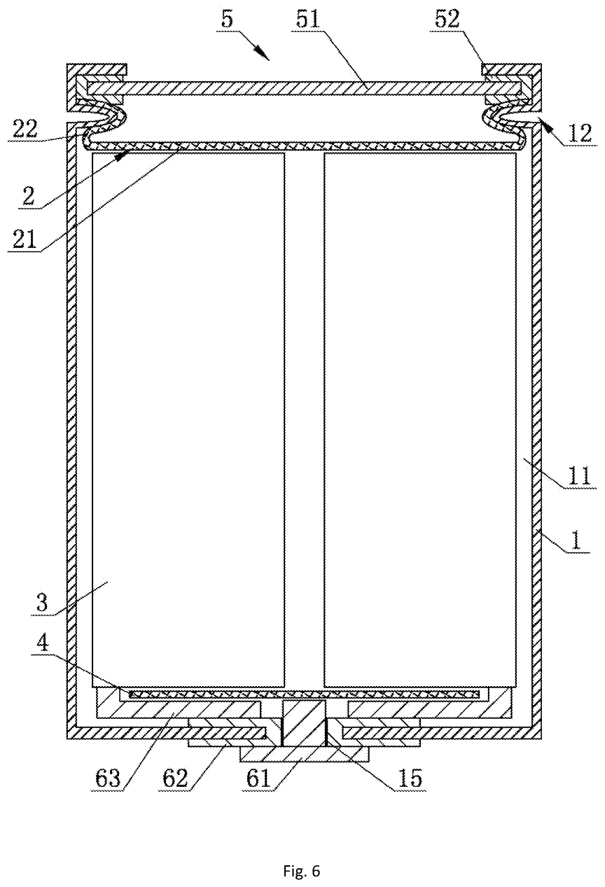

The reference signs are illustrated as follows:

1—housing; 11—accommodating cavity; 12—beading portion; 13—protrusion; 14—opening; 15—electrode terminal hole; 16—first groove; 17—boss; 2—first current collector; 21—first main body portion; 22—second main body portion; 23—buffer segment; 24—welding segment; 25—limiting segment; 3—cell; 4—second current collector; 5—top cover assembly; 51—top cover; 52—first insulating seal; 6—electrode terminal assembly; 61—electrode terminal; 62—second insulating seal; 63—insulating part; 7—second-polarity connecting plate; 71—welding position.

### DETAILED DESCRIPTION OF THE INVENTION

To facilitate understanding by those skilled in the art, hereinafter, the disclosure is further described in combination with embodiments, and the content mentioned in the embodiments is not intended to limit the disclosure.

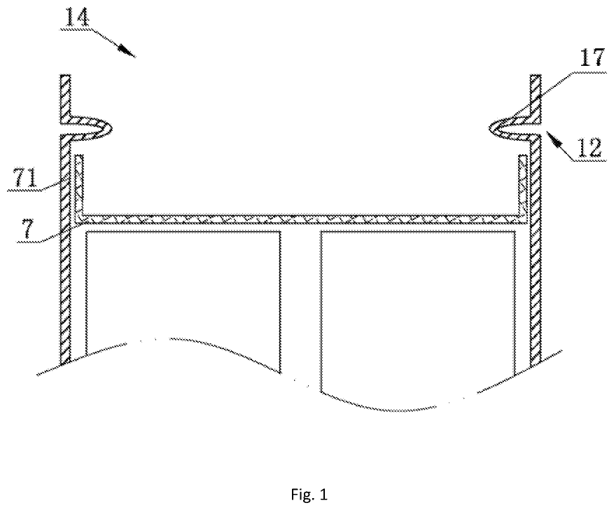

The inventor found that, in the existing cylindrical battery shown in FIG. 1, a first-polarity connecting plate is welded to a first-polarity tab, a second-polarity connecting plate is welded to a second-polarity tab, and then the first-polarity connecting plate is welded to a first-polarity electrode terminal, and a circumferential side wall of the second-polarity connecting plate 7 is welded to an inner side wall of a housing 1, specifically as shown in FIG. 1. A beading portion 12 protrudes inwards by a beading process to form a boss 17, a top cover assembly 51 (not shown in the figure) covers an opening 14 and is lapped on the boss 17, and the welding position 71 between the second-polarity connecting plate 7 and the side wall of the housing is located on a lower side of the boss 17. Hence, in the related art, the welding position 71 and the beading portion 12 need to be reserved, which increases the height of the housing of the battery; this means that when the battery is assembled into a battery module, the battery module needs to reserve more internal space.

### Embodiment 1

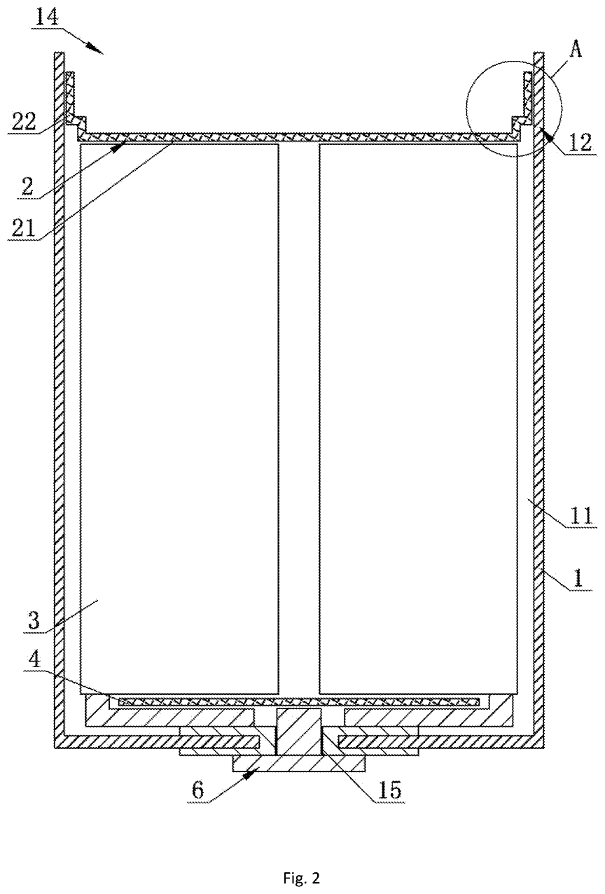

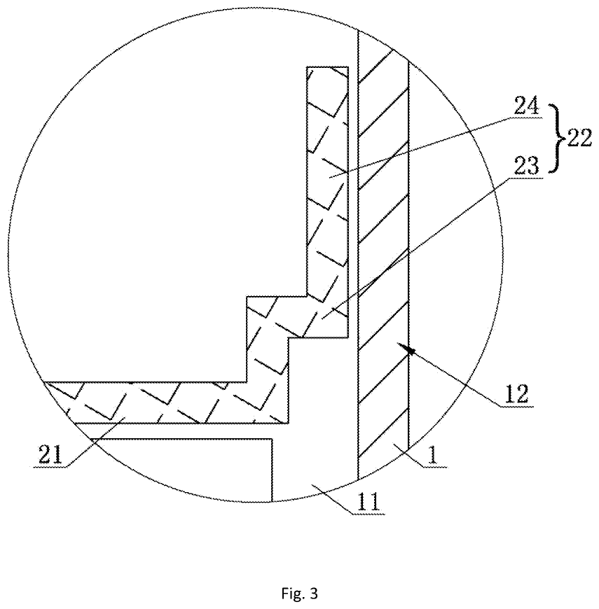

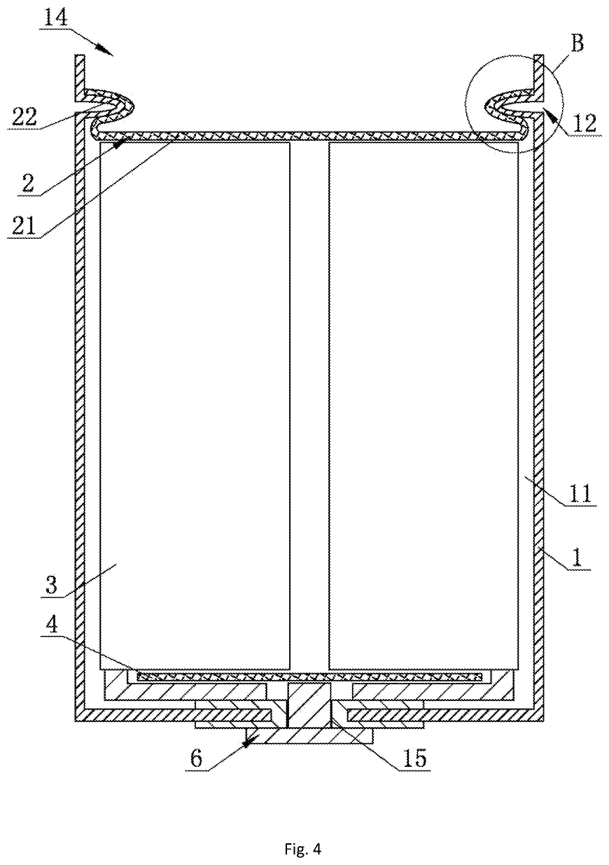

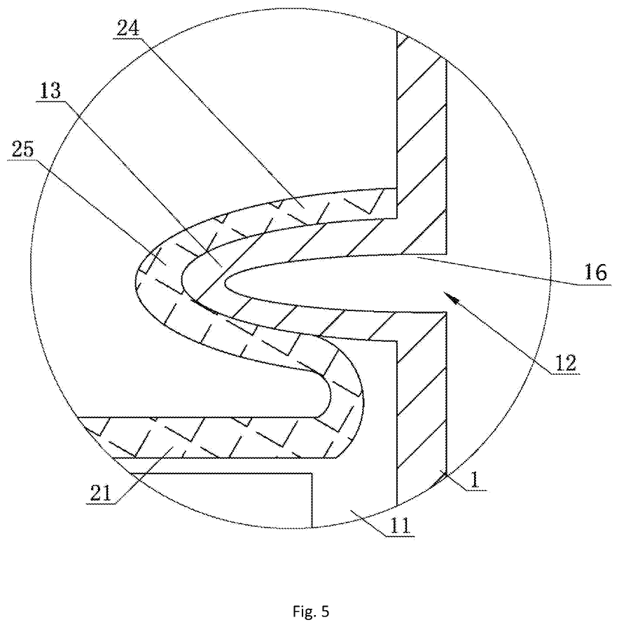

As shown in FIGS. 2-5, a cylindrical battery includes a housing 1, an accommodating cavity 11 arranged in the housing 1, and an opening 14 and an electrode terminal hole 15 which are in communication with the accommodating cavity 11; a cell 3, and a first current collector 2 and a second current collector 4 respectively connected to two ends of the cell 3 are mounted in the accommodating cavity 11. The first current collector 2 is a negative electrode connector, the second current collector 4 is a positive electrode connector, the first current collector 2 faces the opening 14, the second current collector 4 faces the electrode terminal hole 15, and the housing 1 is made of a steel material.

The first current collector 2 includes a first main body portion 21 electrically connected to a tab by welding and a second main body portion 22 extending outwards from an edge of the first main body portion 21; the second main body portion 22 includes a buffer segment 23 and a welding segment 24, one end of the buffer segment 23 is connected to the first main body portion 21, and the other end of the buffer segment 23 is connected to the welding segment 24. A side wall of the housing 1 is provided with a beading portion 12 corresponding to the buffer segments 23. After the cylindrical battery is subjected to a beading process, the beading portion 12 of the housing 1 is recessed inwards to form a first groove 16 on an outer wall of the housing 1, and correspondingly form a protrusion 13 on an inner wall of the housing 1; and a top of the protrusion 13 pushes the buffer segment 23 such that the buffer segment 23 is bent and deformed to form a limiting segment 25; In this case, at least a part of the second main body portion 22 extends from an edge of the first main body portion 21 to the protrusion 13 and covers the protrusion 13. Cross section shapes of the protrusion 13 and the limiting segment 25 are both V-shaped, and the limiting segment 25 and the welding segment 24 abut against the protrusion 13.

The cylindrical battery further includes a top cover assembly 5 covering the opening 14 and an electrode terminal assembly 6 connecting to the second current collector 4; the top cover assembly 5 and the opening 14 are sealed by clamping, and the top cover assembly 5 includes a top cover 51 and a first insulating seal 52; the top cover 51 is embedded in the first insulating seal 52, and after clamping, the top cover 51 is insulated from the housing 1, a liquid injection port is provided at the central position of the top cover 51, and an annular weakened area is further provided on the top cover 51, the annular weakened area is configured for pressure relief when an internal pressure of the battery is excessively high. The electrode terminal assembly 6 includes an electrode terminal 61, a second insulating seal 62 and an insulating part 63, one end of the electrode terminal 61 is connected to the second current collector 4, and the other end of the electrode terminal 61 passes out through the electrode terminal hole 15; the second insulating seal 62 is arranged around an edge of the electrode terminal hole 15, the second insulating seal 62 abuts against the electrode terminal 61 to achieve sealing, and the insulating part 63 is arranged between the second insulating seal 62 and the second current collector 4.

In the embodiment, the welding segment 24 is located at one side of the protrusion 13 and faces towards the opening 14, and during welding, the welding is performed directly through the opening 14, which facilitates a welding operation. Moreover, the welding segment 24 abuts against an upper side surface of the protrusion 13, achieving a high welding yield. The upper side surface refers to a surface of one side of the protrusion 13 facing towards the opening 14.

In the embodiment, a length of the welding segment 24 is less than a length of the limiting segment 25. Such a design ensures that the limiting segment 25 has a sufficient length and is able to cover an end of the protrusion 13, thereby improving the limiting and fixing effect of the limiting segment 25 on the protrusion 13.

In the embodiment, an cross section shape of the buffer segment 23 is zigzag (for example, inverted-Z) and a length of an intermediate segment of the zigzag shape reserves a sufficient length for deformation while also providing a sufficient length for elongation when the welding segment 24 is welded, thereby ensuring release of the buffer segment 23.

Main steps of a manufacturing method of the cylindrical battery in this embodiment mainly include the following two types:

### Type I:

step 1: winding a cylindrical cell;
step 2: flattening a positive electrode tab and a negative electrode tab;
step 3: welding the positive electrode tab to the second current collector 4, and welding the negative electrode tab to the first current collector 2;
step 4: mounting a cell assembly into a housing;
step 5: performing ultrasonic torque welding on the second current collector 4 and a positive electrode terminal 61;
step 6: performing beading on the housing 1, such that the beading portion 12 of the housing 1 is recessed inwards, an outer wall of the housing 1 is recessed to form a first groove 16, and an inner wall of the beading portion 12 is protruded to form a protrusion 13, a top of the protrusion 13 pushes the buffer segment 23 such that the buffer segment 23 is bent and deformed to form a limiting segment 25, the protrusion 13 abuts against a second groove formed by the limiting segment 25, and the protrusion 13 is fixed to the limiting segment 25;
step 7: welding the welding segment 24 to the protrusion 13 at an upper side surface of the protrusion 13; and
step 8: mounting a top cover assembly 5, and performing clamping.

### Type II:

step 1: performing multi-tab die cutting on a positive electrode plate and a negative electrode plate;
step 2: winding a cylindrical cell, and flattening a positive electrode tab and a negative electrode tab;
step 3: welding the positive electrode tab to the second current collector 4, and welding the negative electrode tab to the first current collector 2;
step 4: mounting a cell assembly into a housing;
step 5: performing ultrasonic torque welding on the second current collector 4 and a positive electrode terminal 61;
step 6: performing beading on the housing 1, such that the beading portion 12 of the housing 1 is recessed inwards, an outer wall of the housing 1 is recessed to form a first groove 16, and an inner wall of the beading portion 12 is protruded to form a protrusion 13, a top of the protrusion 13 pushes the buffer segment 23 such that the buffer segment 23 is bent and deformed to form a limiting segment 25, the protrusion 13 abuts against a second groove formed by the limiting segment 25, and the protrusion 13 is fixed to the limiting segment 25;
step 7: welding the welding segment 24 to the protrusion 13 at an upper side surface of the protrusion 13; and
step 8: mounting a top cover assembly 5, and performing clamping.

In the cylindrical battery of the embodiment, by the beading process step, the beading portion 12 of the housing 1 is recessed inwards, the protrusion 13 formed by a protrusion of the inner wall of the beading portion 12 pushes the buffer segment 23 to be bent and deformed; at this moment, the buffer segment 23 is stretched and deformed, cross section shapes of the protrusion 13 and the limiting segment 25 are both V-shaped, and the welding segment 24 abuts against the upper side surface of the protrusion 13; subsequently, the welding segment 24 is directly welded to the upper side surface of the protrusion 13, the welding segment 24 is elongated during welding, the limiting segment 25 is connected to the welding segment 24, and the welding segment 24 has a sufficient length for elongation.

By arranging the buffer segment 23 in combination with the beading process step, beading is performed first and then welding is performed, so that the welding segment 24 is welded to a protruding surface of the beading portion 12, thereby improving the welding yield; moreover, the welding position is arranged corresponding to the beading portion 12, and two positions do not need to be reserved in the battery housing, thereby reducing the battery height. In addition, the arrangement of the buffer segment 23 greatly relieves the stress caused by welding and bending, and thus the first current collector 2 is able to be effectively prevented from cracking, so that the rigidity and stability of the structure at the welding positions are improved, and the use stability and durability of the cylindrical battery are ensured.

### Embodiment 2

An electric apparatus, including the cylindrical battery; the electric apparatus is a vehicle, a mobile phone, a portable apparatus, a laptop, a ship, a spacecraft, an electric toy, an electric tool, and the like. The vehicle is a fuel vehicle, a gas vehicle or a new energy vehicle, and the new energy vehicle is a pure electric vehicle, a hybrid electric vehicle or an extended-range vehicle, etc.; the spacecraft includes an aircraft, a rocket, a space shuttle and a spaceship, etc.; the electric toy includes a stationary or mobile electric toy, such as a game machine, an electric vehicle toy, an electric ship toy, and an electric plane toy; and the electric tool includes a metal cutting electric tool, a grinding electric tool, an assembling electric tool and a railway electric tool, for example, an electric drill, an electric sander, an electric spanner, an electric screwdriver, an electric hammer, an electric hammer drill, a concrete vibrator and an electric planer, etc. The embodiments of the disclosure do not specifically limit the described electric apparatus.

In the illustration of the disclosure, it should be noted that for orientation words, e.g. terms like “center”, “transverse direction (X)”, “longitudinal direction (Y)”, “vertical direction (Z)”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise” etc., they are used to indicate orientation and positional relationships and are based on the orientation or positional relationships as shown in the accompanying drawings, are only used to facilitate the illustration of the disclosure and to simplify the illustration, rather than indicating or implying that a apparatus or element referred to must have a specific orientation, and be constructed and operated in the specific orientation, and therefore the terms cannot be understood as limitation to the specific scope of protection of the disclosure.

In addition, terms such as “first” and “second” are used for purposes of description and cannot be understood as indicating or implying relative importance or significance or implicitly indicating the number of technical features. Thus, features defined by “first” and “second” may explicitly or implicitly include one or more of the features, and in the illustration of some embodiments of the disclosure, the meaning of “a plurality of” is two or more, unless explicitly and specifically defined otherwise.

In the disclosure, unless explicitly specified and defined otherwise, the terms such as “mount”, “connect to”, “connect” and “fix”, etc. should be understood broadly, and for example, may be fixed connection, and may also be detachable connection, or integral connection; and may also be mechanical connection; may be direct connection, and may also be connection by means of an intermediate medium, and may also be interior communication between two elements. For a person of ordinary skill in the art, specific meanings of the described terms in the disclosure could be understood according to specific situations.

The embodiments as described above merely represent embodiments of the disclosure, and the illustration thereof is specific and detailed, but the specific and detailed illustration cannot be understood as limiting the patent scope of the disclosure. It should be noted that for a person of ordinary skill in the art, several modifications and improvements can be made without departing from the concept of the disclosure, and all these modifications and improvements fall within the scope of protection of the disclosure. Therefore, the patent scope of protection of the disclosure shall be subject to the appended claims.

1. A cylindrical battery, comprising:
a housing, the housing is provided with an opening and an accommodating cavity for accommodating a cell;
a first current collector, the first current collector is arranged in the accommodating cavity, and the first current collector comprises a first main body portion and a second main body portion, the first main body portion is connected to the cell, and the second main body portion is connected to the housing;
a side wall of the housing is provided with a beading portion, the beading portion is recessed towards the accommodating cavity to form a first groove on an outer wall of the housing, and correspondingly form a protrusion on an inner wall of the housing, at least a part of the second main body portion extends from an edge of the first main body portion to the protrusion and covers the protrusion.

2. The cylindrical battery according to claim 1, wherein the second main body portion comprises a welding segment and a limiting segment, the limiting segment is connected to the welding segment and the first main body portion, and the second main body portion is connected to the protrusion by the welding segment.

3. The cylindrical battery according to claim 2, wherein the welding segment is located on a side of the protrusion that is oriented towards the opening.

4. The cylindrical battery according to claim 3, wherein a length of the welding segment is less than a length of the limiting segment.

5. The cylindrical battery according to claim 2, wherein the welding segment and the limiting segment abut against the protrusion.

6. The cylindrical battery according to claim 2, wherein a cross section shape of the limiting segment is consistent with a cross section shape of the protrusion.

7. The cylindrical battery according to claim 6, wherein cross section shapes of the limiting segment and the protrusion are both V-shaped.

8. The cylindrical battery according to claim 2, wherein before the beading portion is recessed, the second main body portion comprises the welding segment and a buffer segment located between the welding segment and the first main body portion, and the buffer segment is configured for being bent and deformed to form the limiting segment.

9. The cylindrical battery according to claim 8, wherein a cross section shape of the buffer segment is zigzag or arc-shaped.

10. The cylindrical battery according to claim 2, wherein before the beading portion is recessed, an extension direction of the second main body portion is perpendicular to that of the first main body portion.

11. The cylindrical battery according to claim 1, wherein the first main body portion and the second main body portions are integrally formed.

12. The cylindrical battery according to claim 1, wherein further comprising:
a top cover assembly, the top cover assembly covers the opening and comprises a top cover and a first insulating seal; the top cover is embedded in the first insulating seal, such that the top cover is insulated from the housing.

13. The cylindrical battery according to claim 1, wherein the first current collector is a negative electrode connector.

14. An electric apparatus, comprising the cylindrical battery according to claim 1.

15. The electric apparatus according to claim 14, wherein the second main body portion comprises a welding segment and a limiting segment, the limiting segment is connected to the welding segment and the first main body portion, and the second main body portion is connected to the protrusion by the welding segment.

16. The electric apparatus according to claim 15, wherein before the beading portion is recessed, the second main body portion comprises the welding segment and a buffer segment located between the welding segment and the first main body portion, and the buffer segment is configured for being bent and deformed to form the limiting segment.

17. A manufacturing method for a cylindrical battery, configured for manufacturing the cylindrical battery according to claim 8, comprising the following steps:
S1: winding to form a cylindrical cell, the cylindrical cell has a positive electrode tab and a negative electrode tab;
S2: flattening the positive electrode tab and the negative electrode tab of the cylindrical cell;
S3: welding the positive electrode tab to a second current collector, and welding the negative electrode tab to a first current collector, so as to obtain a cell assembly;
S4: placing the cell assembly into a housing;
S5: performing ultrasonic torque welding on the second current collector and a positive electrode terminal;
S6: performing beading on the housing, such that a beading portion of the housing is recessed inwards, an outer wall of the housing is recessed to form a first groove, and an inner wall of the housing is protruded to form a protrusion, a top of the protrusion pushes the buffer segment such that the buffer segment is bent inwards and deformed to form a limiting segment;
S7: welding the welding segment to the protrusion on a surface of the protrusion away from the cell assembly; and
S8: mounting a top cover assembly, and mounting the top cover assembly to an opening of the housing in a clamping manner.

18. The manufacturing method for a cylindrical battery according to claim 17, wherein before the step S1, the manufacturing method further comprises steps of: die-cutting a positive electrode plate to form a plurality of positive electrode tabs, and die-cutting a negative electrode plate to form a plurality of negative electrode tabs.

19. The manufacturing method for a cylindrical battery according to claim 17, wherein in the step S6, the limiting segment forms a second groove, and the protrusion abuts against the second groove to fix the protrusion and the limiting segment.

20. The manufacturing method for a cylindrical battery according to claim 17, wherein in the step S6, the protrusion and the limiting segment both form V-shaped cross sections.
